(19) United States
(12) Patent Application Publication
(10) Pub. No.: US 2014/0311823 A1
(43) Pub. Date: Oct. 23, 2014

(54) ACOUSTIC INSULATOR HAVING A TORTUOUS PATH

(71) Applicant: GM GLOBAL TECHNOLOGY OPERATIONS LLC, Detroit, MI (US)

(72) Inventors: ALEJANDRO CHAVEZ MARTINEZ, TOLUCA (MX); ALBERTO NAIM KARAM MARROQUIN, TOLUCA (MX); LUIS ANTONIO MURILLO MARQUEZ, SANTA APOLONIA (MX)

(73) Assignee: GM Global Technology Operations LLC, Detroit, MI (US)

(21) Appl. No.: 13/864,718

(22) Filed: Apr. 17, 2013

(51) Int. Cl. B60R 13/08

(52) U.S. Cl. CPC B60R 13/08
USPC 181/286; 156/227

(57) ABSTRACT

An acoustic insulator having a tortuous path located in its interior.

### TECHNICAL FIELD

The field to which the disclosure generally relates to includes an acoustic insulator and methods of making and using the same.

### BACKGROUND

Vehicles may be equipped with pressure release valves.

### SUMMARY OF ILLUSTRATIVE VARIATIONS OF THE INVENTION

One variation of the invention may include a tortuous path in an acoustic insulator.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 depicts rear sheet metal of a vehicle including pressure release valves and acoustic insulators having a tortuous path according to a number of variations of the invention.

FIG. 2 depicts an acoustic insulator having a tortuous path after open molding according to a number of variations of the invention.

FIG. 3 depicts an acoustic insulator having a tortuous path according to a number of variations of the invention.

FIG. 4 depicts a cut view of an acoustic insulator having a tortuous path according to a number of variations of the invention.

### DETAILED DESCRIPTION OF ILLUSTRATIVE VARIATIONS OF THE INVENTION

The following description of the variations is merely illustrative in nature and is in no way intended to limit the invention, its application, or uses.

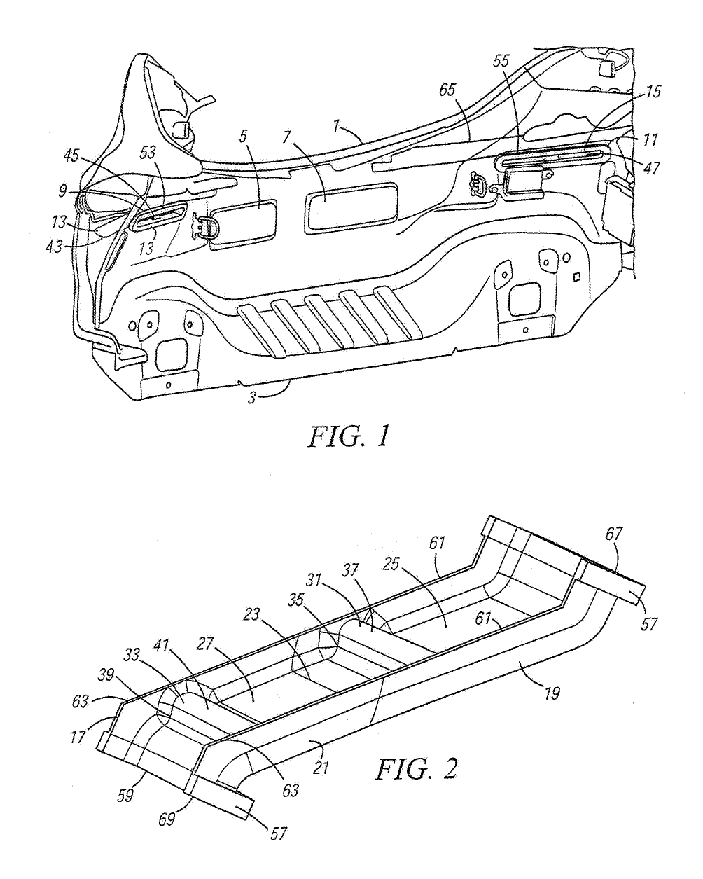

Referring to FIG. 1, in any of a number of variations, a vehicle may have one or more pressure release valves 5, 7 located in the rear sheet metal 1 of the vehicle body 3. The rear sheet metal 1 of the vehicle body 3, in any of a number of variations, may also include one or more openings 9, 11. The openings 9, 11 may be in a variety of shapes, including, but not limited to a square, rectangular, or rounded shape. An acoustic insulator having a tortuous path 13, 15, 17 (shown in FIGS. 1-4) may be shaped in any of a variety of ways to fit inside an opening 9, 11 in the rear sheet metal 1 of the vehicle body 3. An acoustic insulator having a tortuous path 13, 15, 17 may be placed into an opening 9, 11 in the rear sheet metal 1 of a vehicle body 3 which may lower noise entering the interior of the vehicle from the pressure release valves 5, 7 or other sources.

Referring to FIG. 4, in any of a number of variations, the acoustic insulator may have a through hole defining a tortuous path 29 configured inside the acoustic insulator 13, 15, 17 which may further reduce the level of incoming noise from the pressure release valves 5, 7 or other sources. A first protrusion or wall 31 may extend down from the upper interior surface 25 of the acoustic insulator 17 and may have a pair of opposite sloped walls 35 and may have an arched peak 37. A second protrusion or wall 33 may extend up from the lower interior surface 27 of the acoustic insulator 17 and may have a pair of opposite sloped walls 39 and may have an arched peak 41. The first and second wall 31, 33 may be systematically spaced apart from each other in any of a number of variations to reduce the noise going through the pressure release valve acoustic insulator path 29.

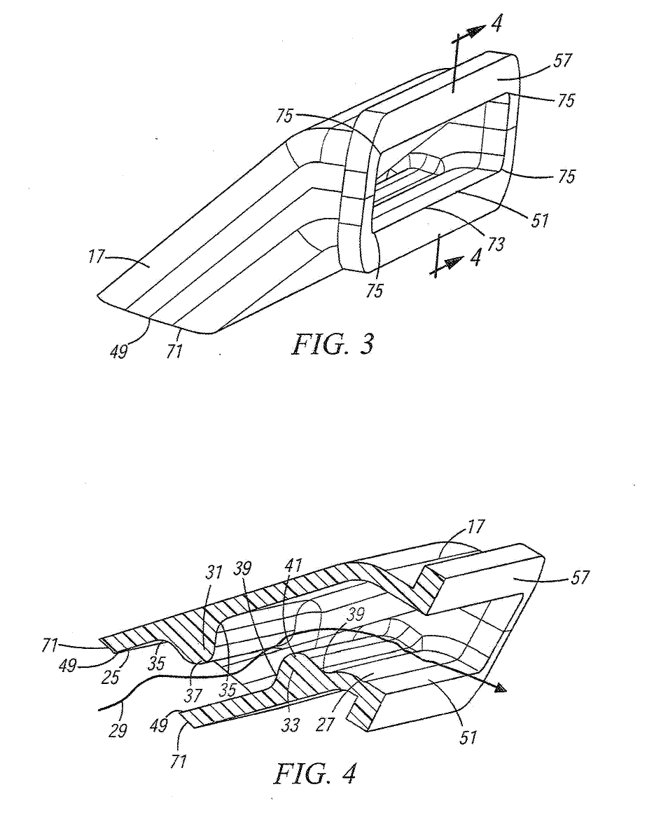

The acoustic insulator having a tortuous path 13, 15, 17 may have an inlet opening 43, 49 (shown in FIGS. 1, 3-4) which may accept incoming noise coming from the pressure release valves 5, 7 or other sources. The inlet opening 43, 49 may have an angled edge, an illustrative variation of which is shown in FIGS. 3-4. The noise may travel through the tortuous path 29. As the noise travels across the first and second walls 31, 33, the acoustic insulator 13, 15, 17 may absorb some of the noise before it is released through the acoustic insulator outlet opening 45, 47, 51. Each of the upper interior surface 25 and the lower interior surface 27 may extend from the inlet opening 43, 49 to the outlet opening 45, 47, 51. The outlet opening may be rectangular 73 in shape with a fillet 75 on each corner of the rectangle 73. The noise level that may enter the acoustic insulator having a tortuous path 13, 15, 17 may substantially decrease as it travels through the insulator because the noise passing through the tortuous path 29 is dissipated more efficiently than in ordinary insulators which may have flat interior surfaces. The through hole defining the tortuous path 29 may extend from the inlet opening 43, 49 to the outlet opening 45, 47, 51.

The acoustic insulator outlet opening 45, 47, 51, in any of a number of variations, may have a lip 53, 55, 57 extending from the perimeter of the outlet opening 45, 47, 51. The lip 53, 55, 57 may have a rectangular shape and may have a chamfer on each corner, an illustrative variation of which is shown in FIGS. 3-4. When the acoustic insulator having a tortuous path 13, 15, 17 is installed into an opening in the sheet metal 9, 11, the lip 53, 55, 57 may press against the outer surface of the sheet metal 65 and may be held in place by interference with the sheet metal 1, illustrative variations of which are shown in FIG. 1.

The acoustic insulator having a tortuous path 13, 15, 17 may be made of any of a number of noise reducing materials including, but not limited to, fiber. The acoustic insulator having a tortuous path 13, 15, 17 may be shaped using any of a number of processes including, but not limited to, fiber thermoforming using natural or synthetic fibers. Referring to FIG. 2, the acoustic insulator having a tortuous path 17 may be created using open mold thermoforming. After thermoforming, the acoustic insulator part 59 may be formed open. Therefore, the open molded acoustic insulator part 59 may have a top component 19 and bottom component 21 separated by a living hinge 23. The living hinge 23 may be located between the top component 19 inlet edge 67 and bottom component 21 inlet edge 69. The living hinge 23 may be a thin flexible hinge made from the same material as the top component 19 and bottom component 21 which may be bent. After molding, the open molded acoustic insulator part 59 may be folded in half at the living hinge 23. The living hinge 23 may be cut or broken in the folding process. The side edges 61 of the top component 19 may then be bonded to the side edges 63 of the bottom component 21 in any of a number of variations including, but not limited to, using an adhesive. After bonding, the acoustic insulator 17 may be a finished part, an illustrative variation of which is shown in FIG. 3.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: an acoustic insulator; wherein the acoustic insulator has an inlet opening, an outlet opening, and a through hole extending therebetween; wherein the acoustic insulator has an internal upper surface and an internal lower surface; wherein the internal upper surface has a first wall extending downward; wherein the internal lower surface has a second wall extending upward.

Variation 2 may include a product as set forth in variation 1 further comprising a lip extending from a perimeter of the outlet opening.

Variation 3 may include a product as set forth in any one of variations 1-2 wherein the inlet opening and the outlet opening are rectangular in shape.

Variation 4 may include a product as set forth in variation 3 wherein the outlet opening has a fillet on each corner.

Variation 5 may include a product as set forth in any one of variations 3-4 wherein the lip has a chamfer on each corner.

Variation 6 may include a product as set forth in any one of variations 1-5 wherein the inlet opening is angled.

Variation 7 may include a product as set forth in any one of variations 1-6 wherein each of the first wall and the second wall includes a pair of opposite sloped walls.

Variation 8 may include a product as set forth in any one of variations 1-7 wherein the first wail and the second wall include an arched peak.

Variation 9 may include a product as set forth in any one of variations 1-8 wherein the first wall extends across a length of the upper surface.

Variation 10 may include a product as set forth in any one of variations 1-9 wherein the second wail extends across a length of the lower surface.

Variation 11 may include a product as set forth in any one of variations 1-10 wherein the first wall and the second wall are spaced apart from each other.

Variation 12 may include a product as set forth in any one of variations 1-11 wherein the acoustic insulator comprises fibers.

Variation 13 may include a product as set forth in any one of variations 1-12 wherein the acoustic insulator is coupled to a hole located in a rear sheet metal of a vehicle body.

Variation 14 may include a method comprising: providing an open molding process to assemble an acoustic insulator; forming the acoustic insulator in an open state; wherein the acoustic insulator comprises a top component and a bottom component and has a living hinge therebetween; folding the acoustic insulator at the living hinge; and bonding the acoustic insulator together.

Variation 15 may include a method as set forth in variation 14 wherein the acoustic insulator comprises thermoformed fiber.

Variation 16 may include a method as set forth in any one of variations 14-15 wherein the acoustic insulator is bonded together using an adhesive.

The above description of select examples of the invention is merely exemplary in nature and, thus, variations or variants thereof are not to be regarded as a departure from the spirit and scope of the invention.

What is claimed is:

1. A product comprising:
an acoustic insulator;
wherein the acoustic insulator has an inlet opening, an outlet opening, and a through hole extending therebetween;
wherein the acoustic insulator has an internal upper surface and an internal lower surface;
wherein the internal upper surface has a first wall extending downward;
wherein the internal lower surface has a second wall extending upward.

2. The product of claim 1 further comprising a lip extending from a perimeter of the outlet opening.

3. The product of claim 2 wherein the inlet opening and the outlet opening are rectangular in shape.

4. The product of claim 3 wherein the outlet opening has a fillet on each corner.

5. The product of claim 3 wherein the lip has a chamfer on each corner.

6. The product of claim 3 wherein the inlet opening is angled.

7. A product as set forth in claim 1 wherein each of the first wall and the second wall includes a pair of opposite sloped walls.

8. A product as set forth in claim 1 wherein the first wall and the second wall include an arched peak.

9. A product as set forth in claim 1 wherein the first wall extends across a length of the upper surface.

10. A product as set forth in claim 1 wherein the second wall extends across a length of the lower surface.

11. A product as set forth in claim 1 wherein the first wall and the second wall are spaced apart from each other.

12. The product of claim 1 wherein the acoustic insulator comprises fibers.

13. A product as set forth in claim 1 wherein the acoustic insulator is coupled to a hole located in a rear sheet metal of a vehicle body.

14. A method comprising:
providing an open molding process to assemble an acoustic insulator;
forming the acoustic insulator in an open state;
wherein the acoustic insulator comprises a top component and a bottom component and has a living hinge therebetween;
folding the acoustic insulator at the living hinge; and
bonding the acoustic insulator together.

15. A method as set forth in claim 14 wherein the acoustic insulator comprises thermoformed fiber.

16. A method as set forth in claim 14 wherein the acoustic insulator is bonded together using an adhesive.
